(19) United States
(12) Patent Application Publication
(10) Pub. No.: US 2021/0368341 A1
(43) Pub. Date: Nov. 25, 2021

(54) SECURE ACCESS FOR 5G IOT DEVICES AND SERVICES

(71) Applicant: Ching-Yu Liao, Hillsboro, OR (US)

(72) Inventor: Ching-Yu Liao, Hillsboro, OR (US)

(21) Appl. No.: 17/398,045

(22) Filed: Aug. 10, 2021

Related U.S. Application Data
(60) Provisional application No. 63/063,863, filed on Aug. 10, 2020.
(60) Provisional application No. 63/065,376, filed on Aug. 13, 2020.

(51) Int. Cl. H04W 12/06; H04W 76/10

(52) U.S. Cl. CPC H04W 12/06; G16Y 30/10; H04W 76/10

(57) ABSTRACT

An apparatus and system for enabling secure access for services provided by IoT Devices in 5G network are described. To provide secure access to an application running on a personal internet of things (IoT) network (PIN) device through another PIN device that acts as an evolved residential gateway (eRG). The registration of a user profile and user identity are described, as are procedures for authentication of the PIN device and the offered services and updating of user profiles, and support for the PIN device and UE gateways.

### PRIORITY CLAIM

This application claims the benefit of priority under 35 U.S.C. 119(e) to U.S. Provisional Patent Application Ser. No. 63/063,863, filed Aug. 10, 2020, and U.S. Provisional Patent Application Ser. No. 63/065,376, filed Aug. 13, 2020, each of which is incorporated herein by reference in its entirety.

### TECHNICAL FIELD

Embodiments pertain to fifth generation (5G) wireless communications. In particular, some embodiments relate to internet-of-things (IoT) devices and services in 5G networks.

### BACKGROUND

The use and complexity of wireless systems, which include 4^{th} generation (4G) and 5^{th} generation (5G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated, especially with the advent of next generation (NG) (or new radio (NR) systems. As expected, a number of issues abound with the advent of any new technology.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3A illustrates UE service access of a personal IoT network (PIN) device in accordance with some embodiments.

FIG. 3B illustrates another UE service access of a PIN device in accordance with some embodiments.

FIG. 3C illustrates another UE service access of a PIN device in accordance with some embodiments.

FIG. 4 illustrates identification and attribute relationship in accordance with some embodiments.

FIG. 5 illustrates a 5G non-roaming architecture of policy and charging control framework in accordance with some embodiments.

FIG. 6 illustrates a UE configuration update procedure for access and mobility management-related parameters in accordance with some embodiments.

FIG. 7 illustrates a UE configuration update procedure for transparent UE policy delivery in accordance with some embodiments.

FIG. 8 illustrates service-specific information provisioning in accordance with some embodiments.

FIG. 9 illustrates a user identity and profile architecture in accordance with some embodiments.

FIG. 10 illustrates an authentication procedure for a PIN device using non-3GPP access and offered PIN services based on a user profiles configuration in accordance with some embodiments.

FIG. 11 illustrates another UE configuration update procedure for transparent UE policy delivery in accordance with some embodiments.

FIG. 12 illustrates a UE subscription procedure to the policy control function (PCF) service for configuration updates in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

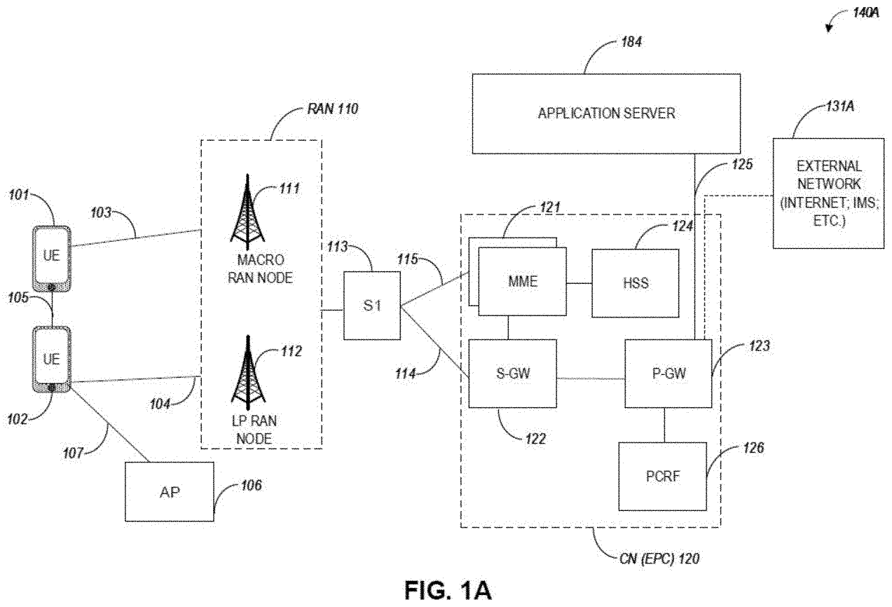

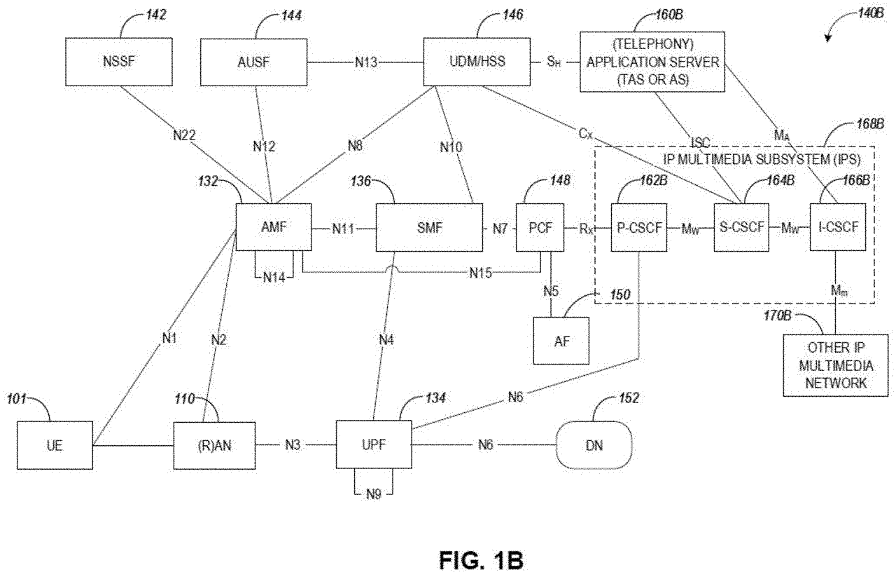

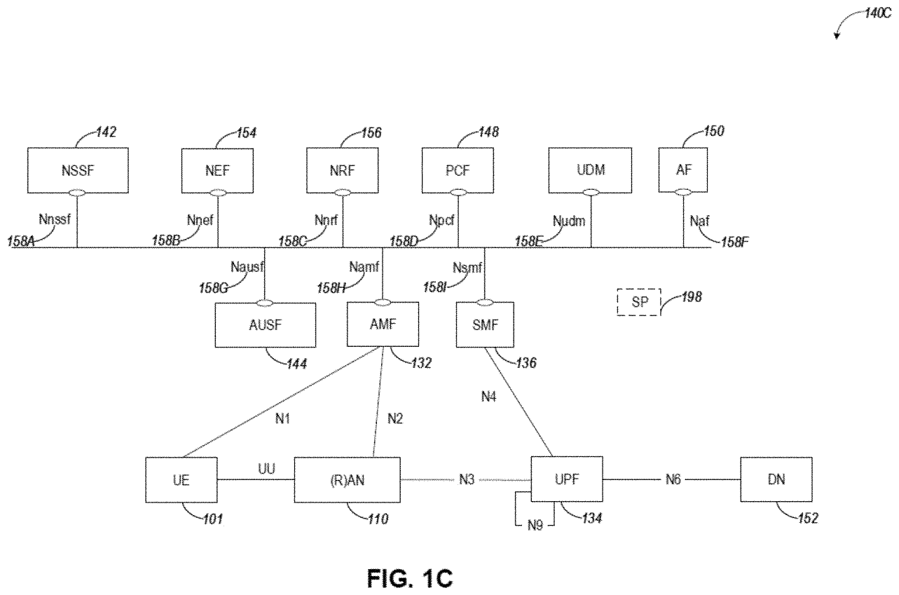

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to he configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MMF) interface 115, which is a signaling interface between the RAN nodes 111 and 112 and MMEs 121.

in this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (CPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT) Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X, communications.

An NG system architecture (or 6G system architecture) can include the RAN 110 and a 5G network core (5GC) 120. The NG-RAN 110 can include a plurality of nodes, such as gNBs and NG-eNBs. The core network 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other SGC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152). N7 (between the SMF 136 and the PCF 148, not shown), N8 (between the UDM 146 and the AMF 132, not shown), N9 (between two UPF 134, not shown), N10 (between the UDM 146 and the SWF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), INnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudst) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

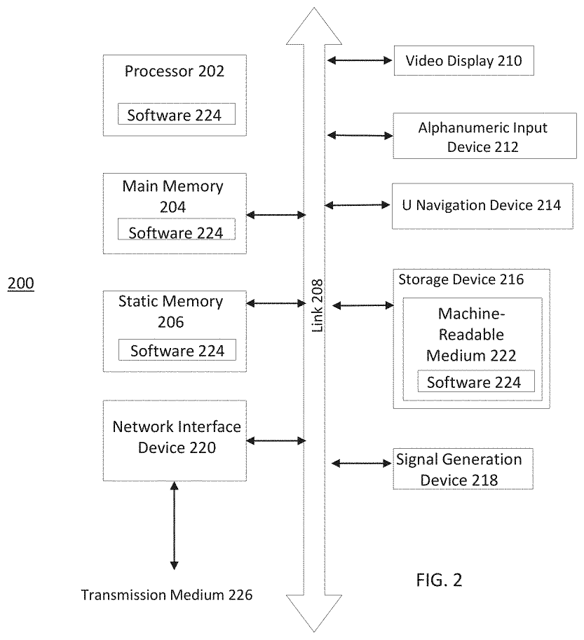

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified. operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (UPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, interact protocol (IP), transmission control protocol (TCP), user datagram protocol (IJDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as IEEE 802.16 family of standards known as WiMax, IEEE 802.15,4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UNITS), freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UNITS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel, 16 (3rd Generation Partnership Project Release 16), 3GPP Rel. 17 (3rd Generation Partnership Project Release 17) and subsequent Releases (such as Rd. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (URA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C, (i.e., Operation of ITS applications in the frequency range 5,470 GHZ to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3A-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-380 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHZ, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g. with highest priority to tier-1 users, followed by tier-2, then tier-3, etc, users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Some of the features in this document are defined for the network side, such as APs, eNBs, NR or gNBs note that this term is typically used in the context of 3GPP fifth generation (5G) communication systems, etc. Still, a UE may take this role as well and act as an AP, eNB, or gNB; that is some or all features defined for network equipment may be implemented by a UE.

Personal IoT network (PIN) may be used to enhance 5GS support of Personal IoT (PIoT) networks, including when the PIoT network is connected to 5GC, either using indirect network communications or other macro network connectivity (e.g., local RAN entities/gateways). The PIoT network is a set of personal IoT devices communicating between themselves and with a UE (e.g., smartphone, residential gateway etc. . . . ) using direct device connections. It is desired to enable 5GS support of Personal IoT networks with the following aspects: interactions between devices in a Personal IoT network and devices in the cellular network, interactions between devices in a Personal IoT network, and onboarding devices with operator managed credentials within the Personal IoT Network from a user/UE (e.g., smartphone) or via a 5G network (e.g., PLMN).

There are an increasing number of PIN devices, e.g., media server, printer, NAS server, etc., that can provide services for users at home or away. These PIN devices are usually behind a wireless gateway. Even in this environment however, there are some security risks found in such settings due to port forwarding (UPnP enabled) and unsecure connectivity provided by the wireless gateway for in-home devices.

When considering a gateway with 5G capability for accessing 5G services, e.g., UE or 5RG (5G residential gateway), it is desirable to enable the support of the secure connectivity for allowing authorized users from anywhere in the world to access authorized services provided by these PIN devices in terms of user authentication and authorization.

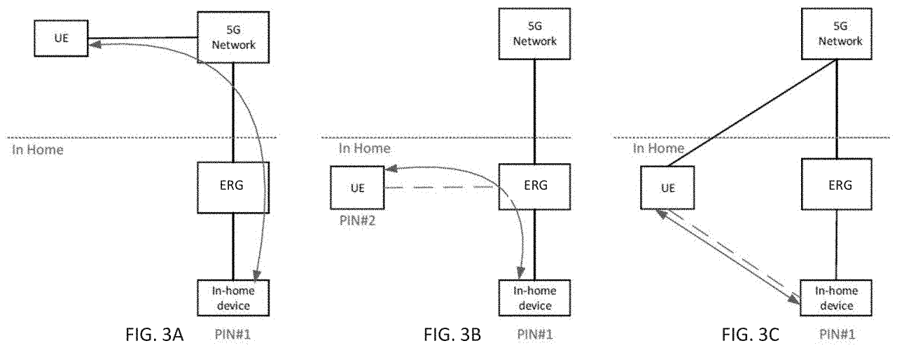

FIG. 3A illustrates UE service access of a PIN device in accordance with some embodiments. FIG. 3B illustrates another UE service access of a PIN device in accordance with some embodiments. FIG. 3C illustrates another UE service access of a PIN device in accordance with some embodiments. Thus, FIGS. 3A-3C show scenarios of the 5G network enabling connectivity service support for the LTE using 3GPP indirect (FIG. 3A), direct (FIG. 3B) communication, or non-3GPP access (FIG. 3C) accessing services provided by PIN devices. Each PIN device may provide one or more services. For example, the PIN device is a media server, smart TV, smart video doorbell, etc., which provide one media service. For another example, the PIN device is a NAS server which can provide multiple services, e.g., media service, web server service, live security cams services, etc.

In FIGS. 3A-3C, a user using an authorized UE, e.g., smartphone or tablet, accesses the service A provided by an PIN device that has connection with 5RG via a non-3GPP access technology, e.g., WiFi, Bluetooth, fiber, 3GPP direct communication, etc. In FIG. 3A: the user/UE is out of home (away) and uses service A via an internet connection over the SG network. In FIG. 3B: the user/UE is at home and uses service A via 3GPP direct communication or non-3GPP access, e.g., WiFi, with 5RG that supports communication between two PINS. FIG. 3C: the user/UE is at home and uses service A directly with the PIN device via a non-3GPP access technology, e.g., Bluetooth, WiFi. In order to support the scenarios depicted in FIGS. 3A-3C, support of secure access for services provided by non-3GPP device, i.e., PIN IoT device, connected to the network via a gateway UE are provide. User identifiers of services provided by PIN devices and user authentication and an authenticator for the services provided by PIN devices are described, as are access to one or more services provided by PIN devices, user profiles and user identifiers for services provided by an PIN device, and gateway UE policies for PIN and out of home settings.

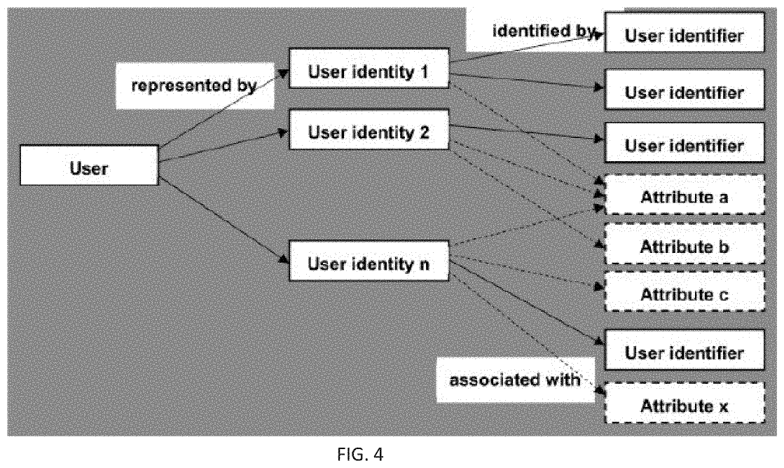

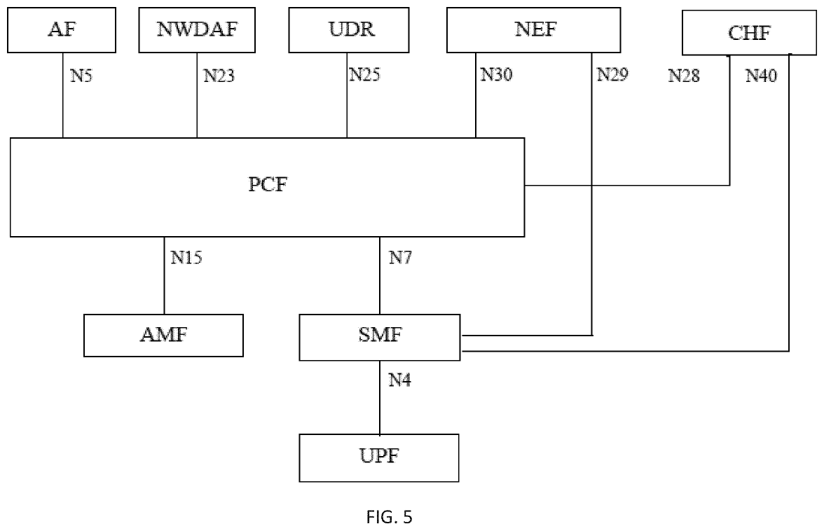

FIG. 4 illustrates identification and attribute relationship in accordance with some embodiments. Referring to 3GPP TS 22:101 clause 26a, the user to be identified could be an individual human user, using a UE with a certain subscription, or an application running on or connecting via a UE, or a device (“thing”) behind a gateway UE. The following service requirements have been supported:

The 3GPP network shall be able to provide a User Identifier for a non-3GPP device that is connected to the network via a UE that acts as a gateway.

The 3GPP network shall support to perform authentication of a User Identity used by devices that are connected via a UE that acts as a gateway.

The 3GPP system shall be able to take User Identity specific service settings and parameters into account when delivering a service.

The 3GPP System shall support to authenticate a User Identity to a service with a User Identifier. This applies to 3GPP services and non-3GPP services that are accessed via the 3GPP System.

A service shall be able to request the 3GPP network to only authenticate users to the service for which the association of the user with a User Identifier has been established according to specified authentication policies of the service.

When a user requests to access a service, the 3GPP System shall support authentication of the User Identity with a User Identifier towards the service if the level of confidence for the correct association of a User Identity with a User identifier complies to specified policies of the service.

3GPP TS 23.503 describes the overall architecture for policy and charging framework in the 5G system in both service-based and reference point representation. In addition to the system shown in FIG. 3A, FIG. 5 illustrates a 5G non-roaming architecture of policy and charging control framework in accordance with some embodiments. FIG. 3A shows a service-based representation of the framework, while FIG. 5 shows a reference point-based representation of the framework.

Section 4.24 (UE Configuration Update) of 3GPP TS 23.502 indicates that the LE configuration may be updated by the network at any time using UE Configuration Update procedure. The UE configuration includes: Access and Mobility Management related parameters decided and provided by the AMF. This includes the Configured Network Slice Selection Assistance Information (NSSAI) and its mapping to the Subscribed Single Network Slice Selection Assistance Information (S-NSSAIs), the Allowed NSSAI and its mapping to Subscribed S-NSSAIs, the Service Gap time and the list of Rejected NSSAIs if the UE Configuration Update procedure is triggered by the AMF after Network Slice-Specific Authentication and Authorization of S-NSSAIs. If the UE and the AMF support Radio Access Capability Signaling (RAGS), this may also include a PLMN-assigned UE Radio Capability ID or alternatively a PLMN-assigned UE Radio Capability ID deletion indication.

UE Policy provided by the PCF: when the AMF wants to change the UE configuration for access and mobility management related parameters the AMF initiates the procedure defined in clause 4.2.4.2. When the PCF wants to change or provide new UE Policies in the UE, the PCF initiates the procedure defined in clause 4.2.4.3. If the UE Configuration Update procedure requires the UE to initiate a Registration procedure, the AMF indicates this to the UE explicitly.

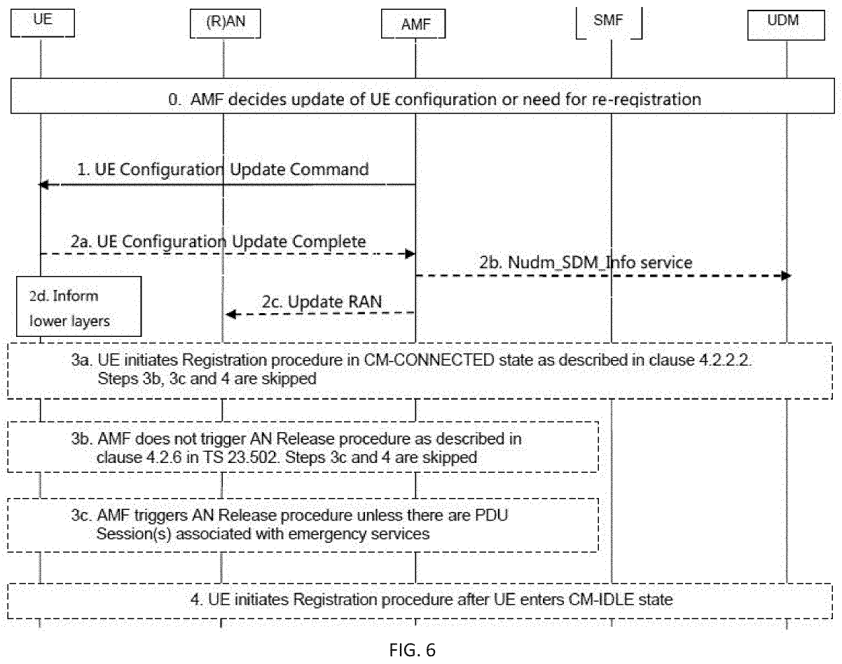

FIG. 6 illustrates a UE configuration update procedure for access and mobility management-related parameters in accordance with some embodiments. The procedure in clause 4.2.4.2 (UE Configuration Update procedure for access and mobility management related parameters) is shown in FIG. 6. The procedure is initiated by the AMF when the AMF wants to update access and mobility management related parameters in the UE configuration.

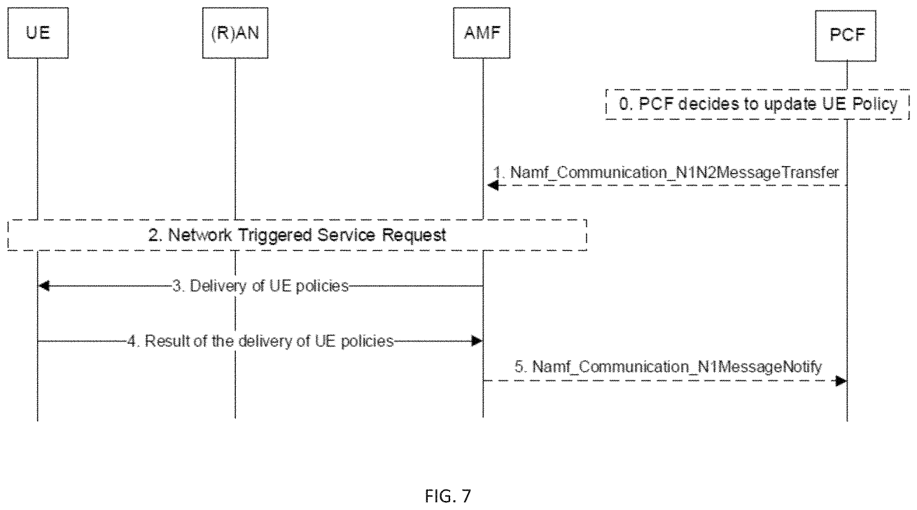

FIG. 7 illustrates a UE configuration update procedure for transparent UE policy delivery in accordance with some embodiments. The procedure in clause 4.2.4.3 (UE Configuration Update procedure for transparent UE Policy delivery) is shown in FIG. 7. This procedure is initiated when the PCF wants to update UE access selection and packet data unit (PDU) Session selection related policy information (i.e., UE policy) in the UE configuration. In the non-roaming case. The visiting PCF (V-PCF) is not involved and the role of the home PCF (H-PCF) is performed by the PCF. For the roaming scenarios, the V-PCF interacts with the AMF and the H-PCF interacts with the V-PCF.

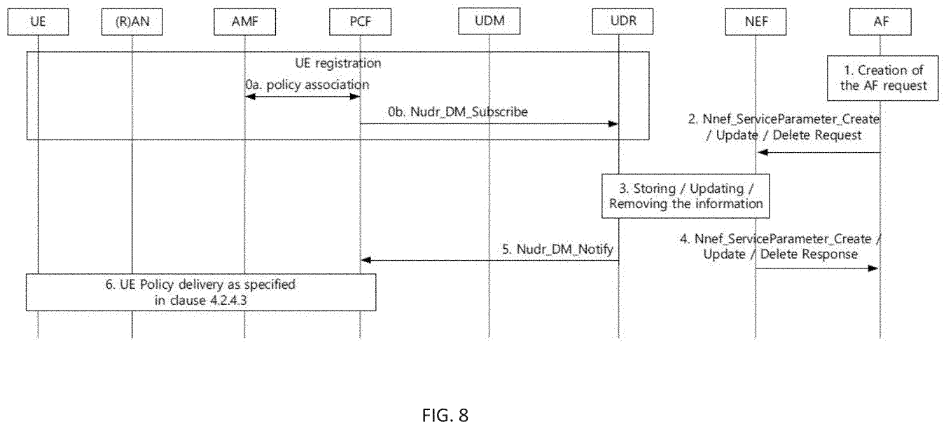

FIG. 8 illustrates service-specific information provisioning in accordance with some embodiments. The procedure in clause 4.15.6.7 (Service specific parameter provisioning) is shown in FIG. 8. This clause describes the procedures for enabling the AF to provide service specific parameters to 5G system via NEF. The AF may issue requests on behalf of applications not owned by the PLMN serving the UE. FIG. 8 shows a procedure for service specific parameter provisioning. The AF uses the Nnef_ServiceParameter service to provide the service specific parameters to the PLMN and the UE.

While the service requirements for users that can be a human, an application running on or connected to a UE, or a device that is connected to a gateway UE, it does not consider the use case of one or more services/applications provided by a device that is connected to a gateway UE.

Solution 1: About User Profile/User Identity/User identifier

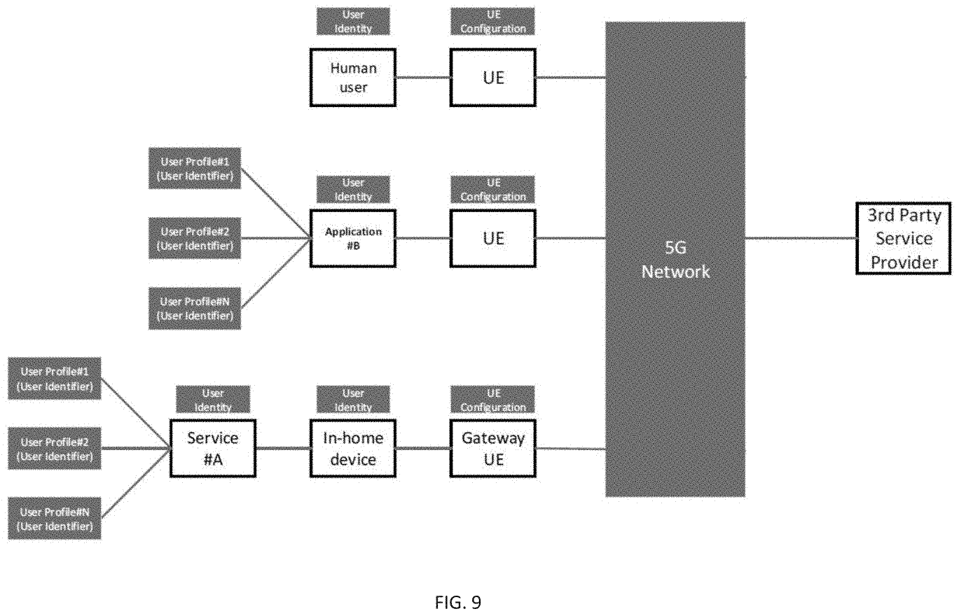

The user to be identified could be: an individual human user, using a UE with a certain subscription, an application running on or connecting via a UE, a device (“thing”) behind a gateway UE, or an application/service provided by a device behind a gateway UE. FIG. 9 illustrates a user identity and profile architecture in accordance with some embodiments. As shown in FIG. 9, in the context of a PIN, the user includes a service (“application”) provided by a PIN device behind a gateway UE.

A service/application has a User Identity and associated one or more User Identifiers or Attributes for this service. The User Identifier of a service for a PIN device is provided by a PIN device served as a PIN or by a gateway UE based on information received from a PIN device.

Referring to TS 22.101, clause 26a, each User Profile contains a User Identifier and includes one or more pieces of the following information:

For 5G services that are used by the UE: additional User Identifiers of the user's User Identities and potentially linked 3GPP subscriptions; used UEs (identified by their subscription and device identifiers); and capabilities the used UEs support for authentication. For a 3rd party service whose applications are running on a UE or connected to a UE: information regarding authentication policies used by different services and slices to authenticate a user for access to these services or slices; User Identity specific service settings and parameters, which include network parameters (e.g., QoS parameters), LP Multimedia Subsystem (IMS) service (e.g. IMS Multimedia Telephony Service (MMTEL) supplementary services) and operator deployed service chain settings; and User Identity specific network resources (e.g., network slice).

For services/applications that are provided by PIN devices behind a gateway UE: User Identifier; Specific service settings and parameters, e.g., active/inactive time, number of accesses, etc.; Authentication/authorization policy and access restriction policy required for the service, which are going to be used to authenticate/authorize a User for accessing to the service of the PIN device; and Credential information, e.g., a password for the authorized service, private and public pairs for encryption/decryption, and hash algorithm for message digital signing, etc.

The 5G network provides/distributes updates of the User Profiles to the users. As such, services provided by PIN devices can be accessed securely and avoid the potential security/privacy risks that invade the PIN devices and services. High Level Service flows includes the following: Step 1, Users configuration and corresponding User Profiles; Step 2, Registration of PIN device and Update of User Profiles for services; Step 3, Accessing services provided by PIN devices; Step 4, UE policies in the home settings.

Solution 1.1

Following solution 1, in Step 1, a 5G service subscriber signs in his account at operator's network that provides 5G connectivity services for all his UE devices. In his account, there are two listed UE devices/subscriptions with gateway UE capabilities, including one smartphone and one 5RG (also called evolved residential gateway (ERG)). In this 5G service subscriber's account, he can create user accounts for all his family members, and indicates Users with User Identities for family members, PIN devices, and services provided by PIN devices.

Further, for each service of the PIN device behind a gateway UE, the 5G service subscriber configures User Profiles, e.g., via scanning the QR code of the device to get some information and editing details manually. For each service identified by a User Identity, the service can have one or more User Profile(s) and each User Profile contains the following information: User Identifier; Specific service settings and parameters, e.g., active/inactive time, number of accesses, etc.; Authentication/authorization policy and access restriction policy required for the service, which are going to be used to authenticate/authorize a User for accessing to the service of the PIN device; and Credential information, e.g. password for the authorized service, security keys for encryption/decryption, and hash algorithm for message digital signing, etc. For an authorized human user(s), the User Profile can indicate the authorized service identified by User Identity and allowed User Identifiers.

Solution 1.2:

Following solution 1.1, in Operation 2:

Step (1a): When an PIN device is turned on, the eRG discovers and connects to the PIN device at the first time, the eRG determines if the PIN device is an authorized User identified by a User Identity indicated in its UE configuration.

If yes, the eRG initiates a secure procedure to register the PIN device by indicating its User Identity and associated User Identifier(s) to the serving 5G network. In addition, for service registration, the eRG can indicate User Identities of active services and their associated User Identifiers, the credentials, service-related information for the active services provided by the PIN device.

If no, the eRG can reject the PIN device for 5G services or request updates of its UE configuration from 5G network based on the last update time of its UE configuration before proceeding registration of PIN device/service to the 5G network.

Step (1b): The serving network of the eRG authenticates User Identity of the PIN device based on its credentials, and then updates User Profiles of the services. In return, the network responds the eRG with the authentication result and updated User Profiles of the registered services.

Step (1c): The serving network of the eRG further provides updated User Profiles of the services to 5G subscriber's home PLMN (HPLMN). The HPLMN of the eRG updates its stored User Profiles of all impacted Users.

Step (1d): Based on serving network's policies, the serving network can update User Profiles of impacted Users and UE configuration towards eRG.

Solution 1.3:

Following solution 1.2, in Step 3, an authorized user using the authorized UE accesses the registered service-A provided by PIN device.

Solution 1.3.1: Case (a): the user/UE is out of Home.

Following solution 1.3: for the User/UE is out of Home, the following steps are used to access service at home.

The User/UE requests to access service-A provided by the PIN device, e.g., using a secure URL, via an eRG. Based on stored User Profiles of the PIN device with allowed Users, the eRG as a gateway UE can determine whether to accept the device access request.

Next, the eRG can further perform user authentication of the service requested by the User/UE based on the security polices and credentials in stored User Profiles of the service.

The eRG forwards the service access request to the PIN device only if the user authentication is successful. Otherwise, the eRG rejects the request for service access.

Solution 1.3.2: Case (b): the user/UE is at Home.

Following solution 1.3: for the User/UE is at Home, the following steps are used to access service at home.

When the User/UE is at home, the eRG discovers and connects the UE acting as an PIN device and using 3GPP direct communication or non-3GPP accesses, based on stored UE policies or user preferences.

The User/UE requests service-A provided by the PIN device via the eRG. Based on stored User Profiles of the PIN device with allowed Users, the eRG as a gateway UE can determine whether to accept the device request from the User, i.e., Violet, using the UE acting as an PIN device.

Next, the eRG can further perform user authentication of the service requested by the User/UE based on the security polices and credentials in stored User Profiles of the service.

The eRG supports communication for forwarding traffic between two PINs.

Solution 1.3.3: Case (c): the user/UE is at home and uses service-A directly with in home device.

Following solution 1.3, for the user/UE is at home, the following steps are used for the user/UE to access service-A directly with in home device.

When the user/UE is at home, the UE acting as a gateway LT discovers and connects with PIN device directly via a non-3GPP access technology, e.g. Bluetooth, WiFi, or via 3GPP direct communication, instead of via indirect communication over the eRG, based on stored UE policies or user preferences.

The User/UE requests service-A provided by the PIN device directly. Based on stored User Profiles of the PIN device with allowed Users, the gateway can determine whether to accept the device access request from the User. i.e., Violet.

Next, the gateway UE can further perform user authentication of the service requested by the User/UE based on the security polices and credentials in stored User Profiles of the service.

The UE supports communication for forwarding traffic between two PINs, e.g., connected earbuds via Bluetooth and connected PIN device, e.g. media server.

Solution 1.4:

Following solution 1.3, step 4, when the authorized User/UE moves from out of home, i.e., case (a), to in-home, i.e., case (b) or case (c), the User can manually determine how the used UE adopts case(a)/case (b)/case(c), or UE can automatically adapt to case(a)/case(b)/case (c) based on the UE policies, including the following information provisioned by the 5G network: one or more operation modes (PIN device, UE, gateway UE); communication methods (3GPP indirect communication, 3GPP direct communication, or non-3GPP access).

Solution 2: procedure for authentication of an PIN device and its offered services

Following solution 1.3.1, i.e., case (a), when the user/UE is out of home, this solution provides method for the user authentication from user out of home requesting to access services provided by an PIN device at home via a gateway UE, e.g., the eRG (5G residential gateway). In this solution, the Gateway UE sends the credential information of the service to the 5G network and relies on the 5G network to distribute the credential information to the authorized users of the services based on stored User Profiles of all Users.

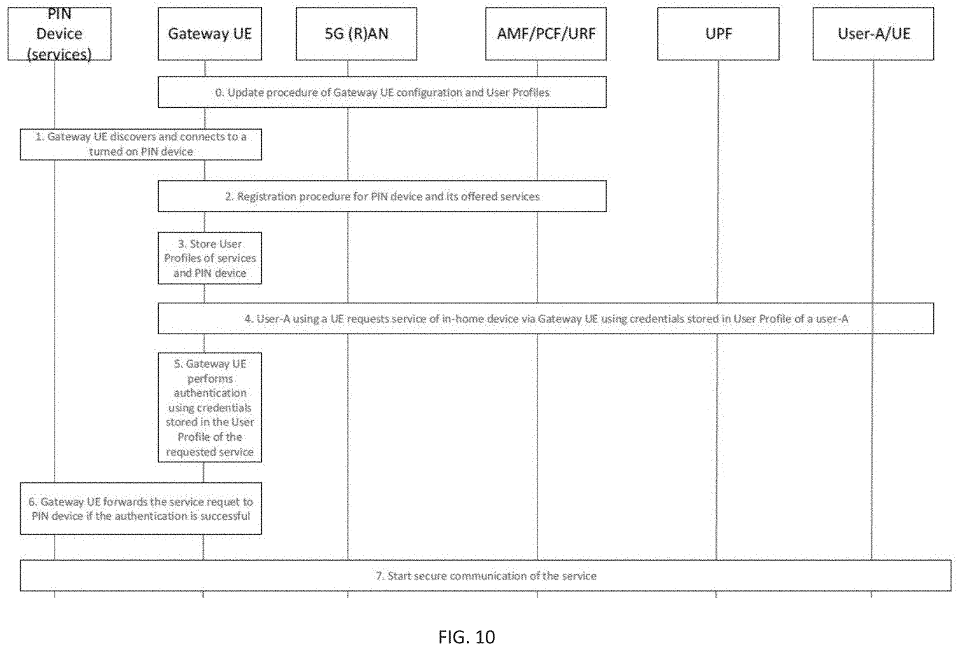

FIG. 10 illustrates an authentication procedure in accordance with some embodiments. In particular, FIG. 10 shows the high-level procedure for authentication of the PIN device using non-3GPP access and its offered PIN services based on User Profiles Configuration. A security mechanism using private/public keys pairs may be used but does not limit the other security mechanisms for user authentication of the service that is provided by a PIN device behind a gateway UE.

In FIG. 10, at step 0, the gateway UE stores the User Profiles of the services/applications provided by the PIN device, in which each User Profile is associated to a User Identifier. Each service/application has a User Identity and is associated one or more User Identifiers or Attributes for this service. If the gateway UE does not have the User Profile of the service user, the gateway UE requests for User Profile updates before continuing to step 1, e.g., using UE Configuration Update procedure as indicated in solution 3. If the gateway UE does not have the User Profile of the service user, the gateway UE continues to step 1, indicating service-related information including the User Identifier, credentials, service type, service description, etc. The 5G network creates the User Profile with standardized Schema associated to the User Identifier and returns the User Profile to the gateway UE in the response message in step 2.

Step 1: PIN device discovers the gateway UE. Then, the gateway UE obtains the active services related information from the PIN device, e.g., by HTTP request and response. For each User Profile, the gateway UE generates one private key and multiple public keys for the authorized users that allowed to access the service.

Step 2: The gateway UE registers the PIN device and its services to the serving 5G network, in which the registration message includes the services related information or the User Profiles of the services provided by the PIN device. For a User Identifier of the service, based on a 5G subscriber's setting for all users and their User Profiles, the 5G network allocates the public keys to the authorized users (identified by User Identity), and updates User Profiles of all impacted users, i.e., authorized users of the services, e.g., with credential information of the allocated public key of the authorized service, hash algorithm, etc. In the response message, the 5G network indicates the result of the registration of the PIN device and its services to the gateway UE. The User Profiles of the service are included in the response message if the content is updated.

Step 3: The gateway UE stores the updated User Profiles. At this step, each User Profile stores the credentials, e.g., private key, and hash algorithm, etc., of the services identified by User identifier, which is to be used for user authentication for the service.

Step 4: When a user/UE requests a service from the PIN device connected to the gateway UE, the user/UE signed the message using indicated hash algorithm and encrypt the message with public key of the service identified by an associated User Identifier based on the User Profile.

Step 5: When the gateway UE receives the service request message for a service provided by the PIN device, the gateway UE performs the user authentication for the requested user by using the private key of the service to ensure that the message is sent by a legitimate user/UE and justifies the hash value of the message to ensure that the message was not modified during message delivery.

Step 6: If the authentication is successful, the gateway UE forwards the service request to the PIN device. Otherwise, the gateway UE rejects the service access request.

Step 7: the communication of the service between the PIN device and the requested user/UE is started.

Solution 3: User Profile Updates Procedure

Following solution 1, this solution provides the details of the User Profile Updates Procedure. The User Profiles of the authorized human user with User Identity and one or more User Identifiers can be provisioned to the UE iii the following procedure as a part of information of the UE configuration as indicated in 3GPP TS 23.502, Clause 4.2.4.3: UE Configuration Update procedure for transparent UE Policy delivery.

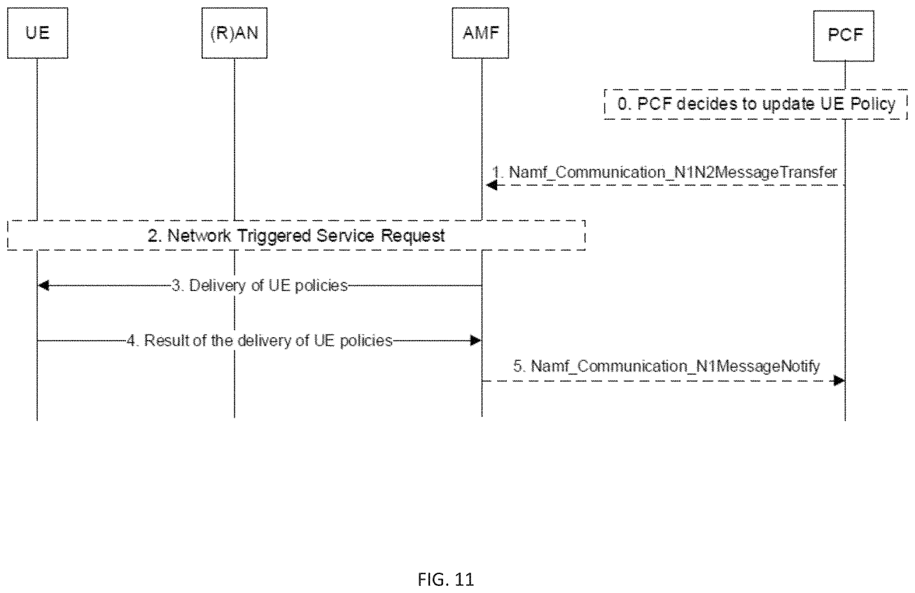

FIG. 11 illustrates another UE configuration update procedure for transparent UE policy delivery in accordance with some embodiments. The procedure of FIG. 11 is initiated when the PCF wants to update UE access selection and PDU Session selection related policy information (i.e., UE policy) in the UE configuration. In the non-roaming case, the V-PCF is not involved and the role of the H-PCF is performed by the PCF. For the roaming scenarios, the V-PCF interacts with the AMF and the H-PCF interacts with the V-PCF.

Solution 3.1:

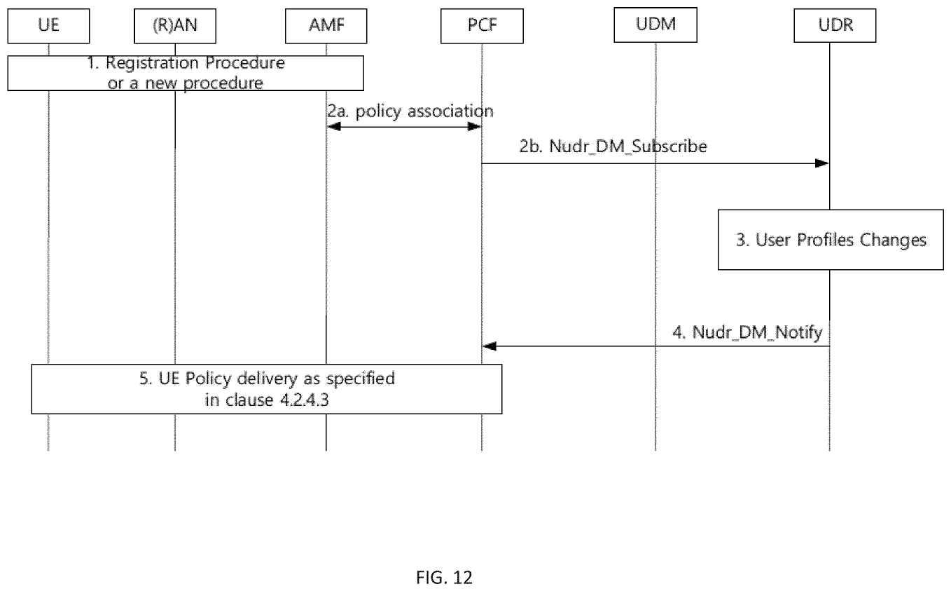

Following solution 3, the User Profiles can be updated requested by the UE. FIG. 12 illustrates a UE subscription procedure to the PCF service for configuration updates in accordance with some embodiments.

Step 1: the UE subscribes the service of the associated PCF for the changes of the User Profiles of indicated User Identifier(s) as part of Registration procedure or a new non-access stratum (NAS) procedure by including the following information in the request message: policy update indication; update policy types, e.g., User Profile; User Identifier that is associated to the User Profile.

If the 5G subscriber configures the User preference identified by the User Identity or associated User identifiers for the User Profile updates as active, the 5G network, e.g., AMF, can directly subscribe the updates services from associated PCF of the UE, without UE requests for such updates.

Step 2: the AMF associates the PCF that stores or knows where to retrieve the required policy information of the UE. In Step 2b, the PCF subscribes to the UDR for the notification services when the indicated policy, information, e.g., update policy types, e.g., User Profile, corresponding User Identifier, etc. is changed.

Step 3: the requested User Profile is changed at the UDR, which may be due to: the updates of services that are provided by the PIN device; the 5G subscriber manually changes the authorized users for using the services provided by the PIN device; or the service settings and parameters changes of the PIN device, etc.

Step 4: the UDR notifies the PCF for the changes of the User Profiles.

Step 5: the UE policy procedure is initiated to update the User Profiles.

Solution 4: Service Requirements for Enabling Secure Access for the Service Provided by PIN Device.

Following solution 1, depending on the UE policies, User Profile, or user preference, an authorized user shall be able to use authorized UE to access the service of an PIN device connected to a gateway UE via 5G network, via a gateway UE using Direct communication, or directly using non-3GPP access with the PIN device.

Solution 4.1:

Following solution 4, the 5G network shall enable support for the user to be identified that is a service/application running on or connected to a PIN device behind a gateway UE.

Solution 4.2:

Following solution 4, the 5G network shall enable support for a user using an authorized UE to securely access the authenticated and authorized services provided by a PIN device behind a gateway UE.

Solution 4.3:

Following solution 4, the User Identifier for a service of a PIN device shall be provided by a PIN device or a gateway UE that connects to the PIN device based on the information obtained from the PIN device.

Solution 4.4:

Following solution 4, the User Profile for a service of a PIN device shall include one or more pieces of the following information: User Identifier; Specific service settings and parameters, e.g. active/inactive time, number of accesses, etc.; Authentication/authorization policy and access restriction policy required for the service, which are going to be used to authenticate/authorize a User for accessing to the service of the PIN device; or Credential information, e.g. password for the authorized service, private and public pairs for encryption/decryption, and hash algorithm for message digital signing, etc.

Solution 4.5:

Following solution 4, the 5G network shall enable support for a gateway UE to store and update a User Profile of a user that is a PIN device or services is running on or connect to the PIN device.

Solution 4.6:

Following solution 4, the 5G network shall enable support for a gateway UE to authenticate a User Identity to a service with a User Identifier and the service is running on or connected to a PIN device behind the gateway UE.

Solution 4.7:

Following solution 4, subject to operator policy, the 5G network shall be able to update User Profiles for the services according to the information shared by the PIN device behind a gateway UE, and update User Profiles of other impacted users.

Solution 4.8:

Following solution 4, the 5G network shall enable support to configure a UE policy with the following information: Authorization of operation modes including PIN UE and gateway UE; Authorized communication method for PIN UE or gateway UE, including 3GPP indirect communication, 3GPP direct communication, or iron-3GPP access; and location information.

Note that a PIN direct connection is the connection between two PIN Elements without any 3GPP RAN or core network entity in the middle. A PIN direct connection could internally be relayed amongst other PIN Elements. When a PIN direct connection is between two PIN Elements that are UEs this direct connection is typically known as a direct device connection.

A PIN Element is a UE and device authorized to communicate within a PIN. A PIN Element with Gateway Capability is a UE PIN Element with the ability to provide (for other PIN Elements) or indirect Network connection (for other PIN Elements) to and from the 5G network. A PIN Element can have both PIN management capability and Gateway Capability. A PIN Element with Management Capability is a PIN Element with PIN management Capability has capability to manage the PIN. A Personal IoT Network is a configured and managed group of at least one UE and one or more PIN Elements or UEs that are (pre-)authorised to communicate with each other. The configuration and management of the PIN can be maintained locally or by the 3GPP network. A PIN-User is the person who owns the PIN with respective subscriptions at one service provider.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can he seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE), the apparatus comprising:
processing circuitry configured to:
generate, based on a UE subscription, a request for communication with a personal internet of things (IoT) network (PIN) device in a local network that is connected to a local gateway through a 5th generation (5G) network for secure access to the PIN device, the local network in one of a home network, a Customer Premise Network (CPN) in a residential environment, or the PIoT network;
encode, for communication to the PIN device, signaling to establish the communication with the PIN device to provide a service, the UE being an authorized UE to communicate with the PIN device through secure access to the PIN device, the UE configured to provide:
a user identity and associated user identifiers and credentials of at least one of the PIN device or an application running on the PIN device,
decode, from the PIN device, the service; and
a memory configured to store information of the PIN device.

2. The apparatus of claim 1, wherein the 5G network is configured with authorization information of the PIN device or applications running on the PIN device.

3. The apparatus of claim 1, wherein the local gateway is an evolved residential gateway (eRG) or a UE with gateway capability.

4. The apparatus of claim 1, wherein the UE is out of the local network and is configured to communicate with the PIN device through the local gateway and the 5G network.

5. The apparatus of claim 1, wherein the UE is in the local network and is authorized and configured to communicate with the PIN device through the local gateway.

6. The apparatus of claim 1, wherein the UE is in the home network and the processing circuitry is further configured to select between direct communication with the PIN device without traversing the local gateway through a non-3GPP access technology or 3GPP direct communication.

7. The apparatus of claim 1, wherein a processing circuitry of the 5G network is configured to create, for transmission to the 5G network based on a 3GPP subscription, identification information as user identities of an PIN device or one or more services provided by the PIN device and to configure user profiles for the user identities.

8. The apparatus of claim 7, wherein:
for each service identified by a particular user identity, a user profile of the service is configured, and
the user profile contains:
another user identifier of the user profile,
service settings and parameters of the service,
an authentication or authorization policy, and access restriction policy to use the service, the authentication or authorization policy and access restriction policy configured to authenticate or authorize a UE to access the PIN device or application running on the PIN device, and
credential information for the service.

9. The apparatus of claim 8, wherein:
the service settings and parameters include an amount of active or inactive time and a number of accesses, and
the credential information includes a password for the service, security keys for encryption and decryption, and a hash algorithm for digital signing.

10. An apparatus for a gateway of personal internet of things (IoT) network (PIN), the apparatus comprising:
processing circuitry configured to:
discover a PIN device in a local network;
authenticate the PIN device using authentication information configured by a 5^{th} generation (5G) network or provided by the PIN device;
establish a direct connection with the PIN device after authentication of the PIN device;
provide gateway capability between a 5^{th} generation (5G) network and the PIN device as an evolved residential gateway (eRG) or a gateway UE in the local network;
relay signaling, from the UE, to request a service of the PIN device, the UE being authorized to request access to the PIN device; and
relay, from the PIN device, the service to the UE in response to successful authentication based on a user profile that contains a user identifier, service settings and parameters of the service, an authentication and access restriction policy to access the PIN device or an application running on the PIN device, and credential information for the service; and
a memory configured to store the authentication information.

11. The apparatus of claim 10, wherein the UE is out of the home network and the processing circuitry is configured to provide access for the UE to the PIN device through the 5G network, the 5G network configured to provide secure access to the PIN device and the service provided by the PIN device for authenticated and authorized UEs.

12. The apparatus of claim 10, wherein the UE is in the home network and the processing circuitry is configured to provide access for the UE to the PIN device without the 5G network.

13. The apparatus of claim 10, wherein:
the processing circuitry is further configured to register the PIN device and update user profiles for the service provided by the PIN device, and
during registration, the processing circuitry is configured to:
discover and connected to the PIN device upon initial activation of the PIN device,
determine whether the PIN device is an authorized user identified by a user identity in a UE configuration of the PIN device,
authenticate, with the 5G network after authorization, the user identity based on user credentials in the UE configuration, and
generate, for transmission to the 5G network, an update after authentication, the update indicating a user profile of the service provided by the PIN device, and determine a response with an authentication result and updated user profiles of the service.

14. The apparatus of claim 13, wherein during registration, the processing circuitry is configured to:
generate, for transmission to a home public land mobile network (HPLMN), an updated user profile of the service and store the user profile for all impacted users of the update, and
based on serving network policies, update user profiles of impacted users and UE configuration due to addition of the PIN device.

15. The apparatus of claim 10, wherein the processing circuitry is further configured to:
register an application that provides the service, and
in response to reception of a request from another UE in the home network to use an application associated with the service from the PIN device, determine whether to use a PIN direct connection to provide the service to the other UE based on stored UE policies or user preferences.

16. The apparatus of claim 15, wherein in response to reception of the request from the other UE, the processing circuitry is further configured to:
determine whether to accept the request,
perform user authentication of the application based on security polices and credentials stored in user profiles associated with the application,
forward the request to the PIN device in response to successful user authentication and otherwise generate a rejection of the request for transmission to the other UE, and
in response to successful user authentication, forward the service to the other UE.

17. The apparatus of claim 16, wherein the processing circuitry is further configured to, based on a configuration of the application, generate a request to the 5G network for 5G user authentication to perform the user authentication.

18. A non-transitory computer-readable storage medium that stores instructions for execution by one or more processors of a gateway of a personal internet of things (IoT) network (PIN), the one or more processors to configure the gateway to, when the instructions are executed:
discover a PIN device in a local network;
authenticate the PIN device using authentication information provided by the PIN device;
establish a direct connection with the PIN device after authentication of the PIN device;
register the PIN device and update user profiles for applications and services provided by the PIN device;
provide, for a user equipment (UE), gateway capacity between a 5^{th} generation (5G) network and the PIN device as an evolved residential gateway (eRG) in the home network to provide gateway capacity between the UE and the PIN device;
relay signaling, from the UE, to request a media service of the PIN device, the UE being authorized to request access to the PIN device; and
relay, from the PIN device, the media service to the UE in response to authentication by the PIN device of a user profile for the UE that contains a user identifier, service settings and parameters of the media service, an authentication and access restriction policy to access the PIN device or an application running on the PIN device, and credential information for the media service.

19. The medium of claim 18, wherein during registration the one or more processors further configure the gateway to, when the instructions are executed:
discover and connected to the PIN device upon initial activation of the PIN device,
determine whether the PIN device is an authorized user identified by a user identity in a UE configuration of the PIN device,
authenticate, with the 5G network after authorization, the user identity based on user credentials in the UE configuration, and
generate, for transmission to the 5G network, an update after authentication, the update indicating a user profile of the media service provided by the PIN device, and determine a response with an authentication result and updated user profiles of the media service.

20. The medium of claim 18, wherein the one or more processors further configure the gateway to, when the instructions are executed:
in response to reception of a request from another UE in the home network to use an application associated with the media service from the PIN device:
determine whether to accept the request,
perform user authentication of the application based on security polices and credentials stored in user profiles associated with the application, and
forward the request to the PIN device in response to successful user authentication and otherwise generate a rejection of the request for transmission to the other UE,
in response to successful user authentication, forward the media service to the other UE, and
determine whether to use a PIN direct connection to provide the media service to the other UE based on stored UE policies or user preferences.
